(19) United States
(12) Patent Application Publication
(10) Pub. No.: US 2008/0285756 A1
(43) Pub. Date: Nov. 20, 2008

(54) RANDOM SHARED KEY

(75) Inventors: Dmitry Vladislavovich Chuprov, Saint Petersburg (RU); Vladimir Eduardovich Shmakov, Saint Petersburg (RU)

Correspondence Address: CHRISTENSEN O'CONNOR JOHNSON KINDNESS PLLC, 1420 FIFTH AVENUE, SUITE 2800, SEATTLE, WA, 98101-2347, US

(73) Assignee: DMVICH SOFTWARE, LLC, Wilmington, DE (US)

(21) Appl. No.: 12/052,653

(22) Filed: Mar. 20, 2008

Related U.S. Application Data
(60) Provisional application No. 60/918,902, filed on Mar. 20, 2007.

(51) Int. Cl. H04L 9/06

(52) U.S. Cl. 380/277

(57) ABSTRACT

A key server is configured to execute on a computer. The key server is further configured to programmatically respond to a request by a sender by generating a message identifier connected with a message to be communicated and a random shared key for encrypting the message by the sender if the sender has registered with the key server. The key server is yet further configured to programmatically respond to a receiver by extracting the random shared key for decrypting the message if the receiver has registered with the key server, the receiver provides the message identifier to the key server, and the receiver is an intended recipient of the message.

### CROSS-REFERENCE TO A RELATED APPLICATION

This application claims the benefit of U.S. Provisional Application No. 60/918,902, filed Mar. 20, 2007, which is incorporated herein by reference in its entirety.

### BACKGROUND

A combination of encryption (to prevent eavesdropping) and client authentication (to verify the identity of the sender and recipient) can reduce, but not eliminate, security issues connected with internet communications. One technique for doing so is known as Public Key Infrastructure, or PKI. However, PKI does not scale well to large organizations. Another technique for managing encryption keys is to have the clients manage the encryption keys. However, as the number of message recipients grows, clients have a difficult time keeping track of the exploding number of required encryption keys.

### BRIEF DESCRIPTION OF THE DRAWINGS

The foregoing aspects and many of the attendant advantages of the disclosed subject matter will become more readily appreciated as the same become better understood by reference to the following detailed description, when taken in conjunction with the accompanying drawings, wherein:

FIG. 1A is a block diagram illustrating an exemplary client device for sending and receiving secure e-mail according to various embodiments of the present disclosure;

FIG. 1B is a block diagram illustrating an exemplary key server for authenticating clients and managing encryption keys according to various embodiments of the present disclosure;

FIG. 2 is a block diagram illustrating an exemplary network communication system for the secure exchange of encryption keys and the sending and receiving of secure e-mail according to various embodiments of the present disclosure; and

FIGS. 3A-3H are process diagrams illustrating exemplary methods for managing encryption keys for sending and receiving secure e-mail in accordance with various embodiments of the present disclosure.

### DETAILED DESCRIPTION

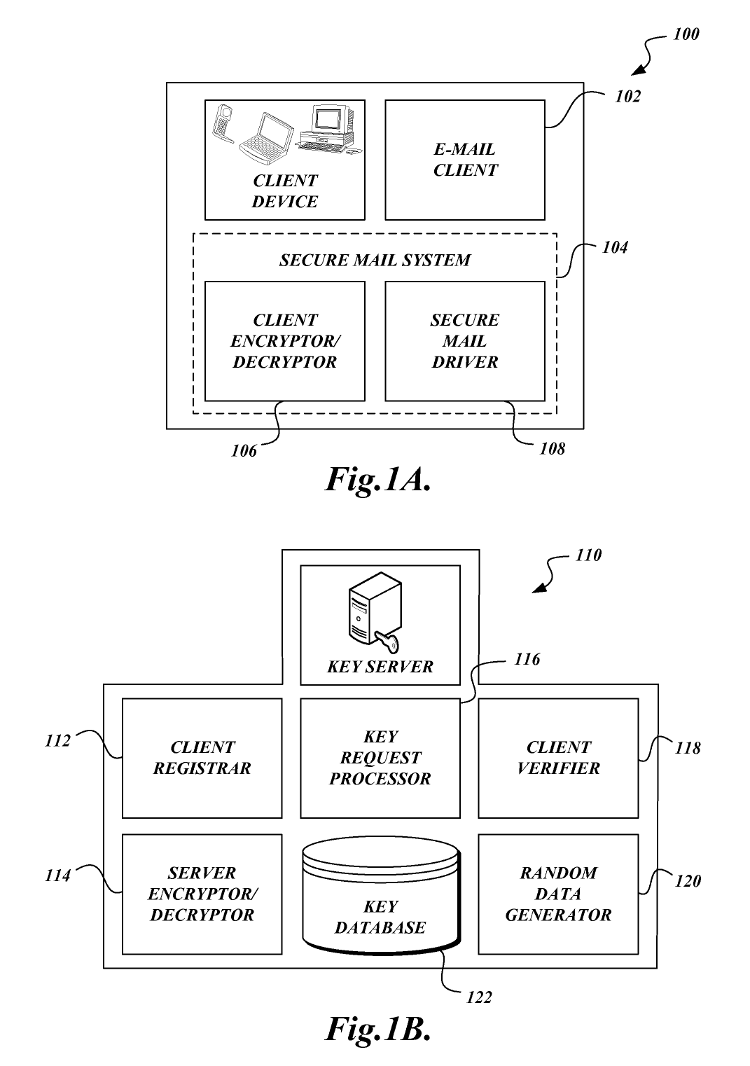

FIG. 1A illustrates a client device 100 suitable for sending and receiving secure e-mail. The client device 100 may take many different forms. For example, one suitable form of the client device 100 may be a general purpose desktop computer, while another suitable form of the client device 100 may be a mobile phone, a laptop computer, a PDA, a video game console, and so on.

The client device 100 comprises an e-mail client 102. The e-mail client 102 may be any e-mail client program suitable for sending Internet e-mail, such as OUTLOOK® Express. Embodiments of the present disclosure in which the e-mail client 102 is a mass-marketed e-mail client program such as this allow users to send secure e-mail without requiring additional training and do not require a substantial software development effort. In one embodiment, the e-mail client 102 is customized for sending and receiving secure e-mail.

The client device 100 further comprises a secure mail system 104. The secure mail system 104 comprises a client encryptor/decryptor 106. The client encryptor/decryptor 106 encrypts and decrypts communication between the client device 100 and a key server 110, and encrypts and decrypts e-mail sent to other client devices. One embodiment of the secure mail system 104 also comprises a secure mail driver 108. The secure mail driver 108 requests and receives encryption keys from a key server 110 and otherwise manages the process of sending secure e-mail.

FIG. 1B illustrates the key server 110. The key server 110 registers the client device 100, authenticates the client device 100, and responds to key requests from any client device including the registered, authenticated client device 100. The key server 110 is communicatively coupled to a key database 122, in which the key server 110 stores identifying information for each registered client device 100. This identifying information may include a public encryption key that is associated with the client device 100 and that is used to secure communications between the client device 100 and the key server 110. One skilled in the art will recognize that the key database 122 may reside on the same hardware as the key server 110 or on different hardware from the key server 110.

The key server 110 further comprises a client registrar 112. The client registrar 112 registers each client device 100 by accepting a public encryption key for the client device 100 and storing it in the key database 122. This registration may also comprise storing user credentials such as a user name and a password associated with the client device 100 in the key database 122 along with the public encryption key of the client device 100.

The key server 110 further comprises a key request processor 116. The key request processor 116 handles requests for random shared keys, which requests are submitted by the client device 100. The key server 110 further comprises a client verifier 118, which verifies the identity of the client device 100. In other words, the client verifier 118 determines whether the client device 100 is in fact the client device 100 associated with a given request for a random shared key.

The key server 110 also comprises components suitable for handling secure communication. These components comprise a server encryptor/decryptor 114 and a random data generator 120. The server encryptor/decryptor 114 encrypts and decrypts communication between the key server 110 and the client device 100. The random data generator 120, in response to receiving a request from the client device 100, generates random data to be used as a message ID. The random data generator 120 also generates encryption keys, including a public and private key pair for the key server 110 and random shared keys in response to requests for such keys from the client device 100.

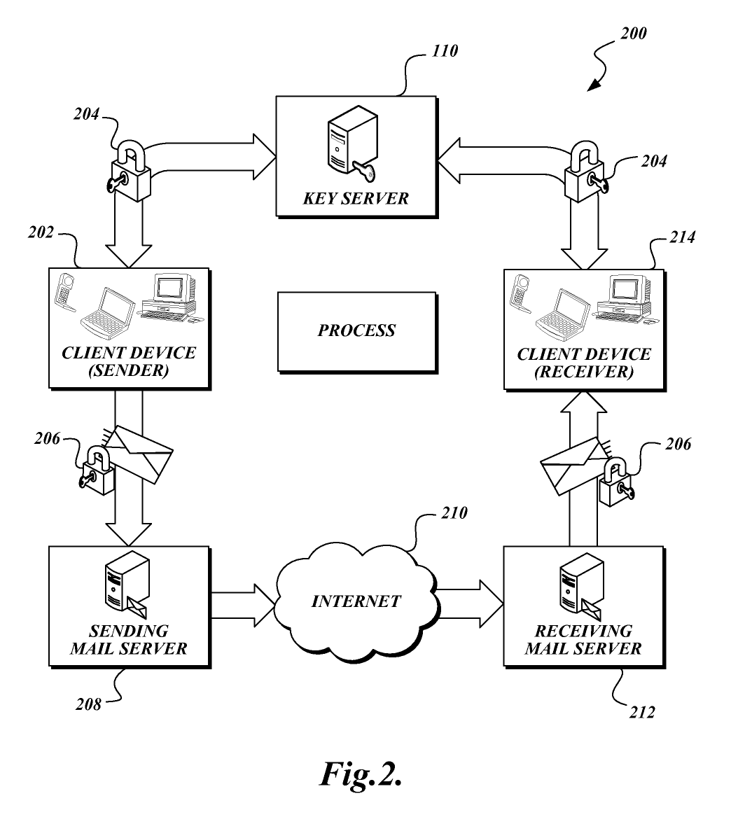

FIG. 2 illustrates an exemplary system 200 for the management of encryption keys and the sending and receiving of secure e-mail. A sender 202 and a receiver 214 are client devices, such as the client device 100. In one embodiment, the sender 202 and the receiver 214 register with the key server 110 before sending or receiving secure e-mail. During this registration process, each client device 100 generates a key pair, including a public key and a private key, and transmits the public key to the key server 110. The key server 110 stores this public key of the registering client device 100 and in turn sends a public key of the key server 110 to the registering client device 100.

To send a piece of protected e-mail once registered, the sender 202 requests a random shared key from the key server 110. The key server 110 first determines whether the sender 202 is allowed to send secure e-mail based on factors such as permissions granted to the particular sender 202, the status of the intended recipients of the message, and so on. If the sender 200 is allowed to send secure e-mail to the intended recipients, the key server 110 generates a message ID and a random shared key 204. The key server 110 securely transmits the message ID and random shared key 204 to the sender 202. The sender 202 encrypts the message using the random shared key, adds the message ID to the encrypted message, and sends the piece of protected e-mail 206 to a sending mail server 208. The sending mail server 208 can be any suitable type of server that can send Internet e-mail, such as an SMTP server. The sending mail server 208 transfers the piece of protected e-mail 206 to a receiving mail server 212 via a network, such as the Internet 210. The receiving mail server 212 is any suitable type of server that can receive Internet e-mail and distribute Internet e-mail to a receiving client, such as an IMAP server or a POP3 server.

One skilled in the art recognizes that the sending mail server 208 and the receiving mail server 212 may be the same server. One skilled in the art also recognizes that the sending mail server 208 and the receiving mail server 212 may be on separate servers located on the same local area network, thus not requiring the piece of protected e-mail 206 to be transmitted through the Internet 210.

In one embodiment of the system 200, the sender 202 does not encrypt the headers required for delivery of the piece of protected e-mail 206. Therefore, the sending mail server 208 and the receiving mail server 212 do not require any special knowledge or configuration to take part in the system 200, but instead may route and deliver the piece of protected e-mail 206 in the same way as any other e-mail.

The receiver 214 receives the piece of protected e-mail 206 from the receiving mail server 212. The receiver 214 extracts the message ID from the piece of protected e-mail 206 and uses the message ID to request the random shared key 204 from the key server 110. If the key server 110 verifies that the receiver 214 was an intended recipient of the piece of protected e-mail 206, the key server 110 responds with the random shared key 204 used to encrypt the message. The receiver 214 then uses this random shared key 204 to decrypt the contents of the piece of protected e-mail 206.

In embodiments of the present system 200, the contents of the piece of protected e-mail 206 leave the sender 202 encrypted. In embodiments, the key server 110 refrains from possessing the contents of the piece of protected e-mail 206 and possesses the random shared key 204 and the list of intended recipients. Thus, if a malicious third party were to gain access to the key server 110, the malicious third party would not have access to the contents of the piece of protected e-mail 206. The present system 200 is also flexible. Although it is primarily described herein as relating to the sending and receiving of a piece of protected e-mail 206, other embodiments of the system 200 can be used for exchanging other forms of electronic communication, such as instant messages, text messages, and so on.

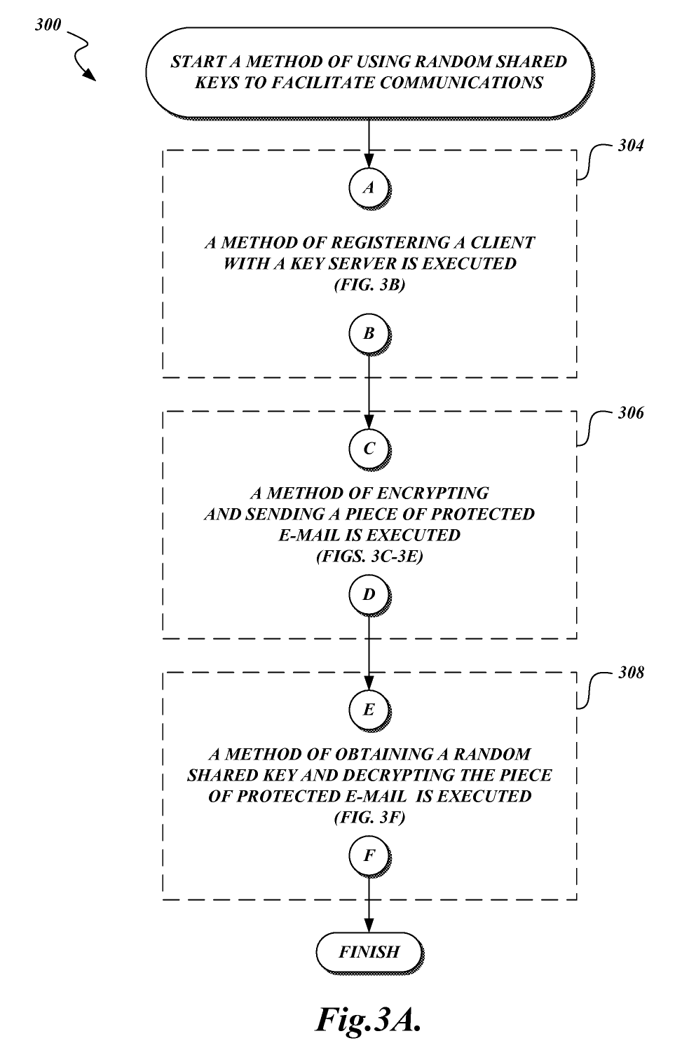

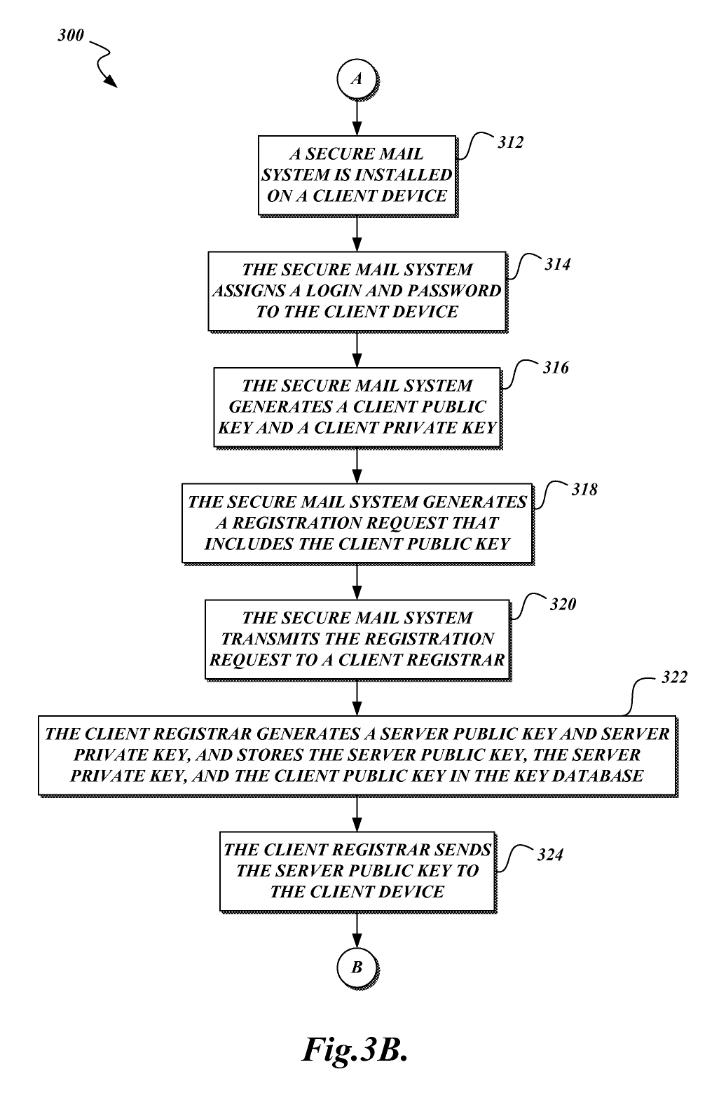

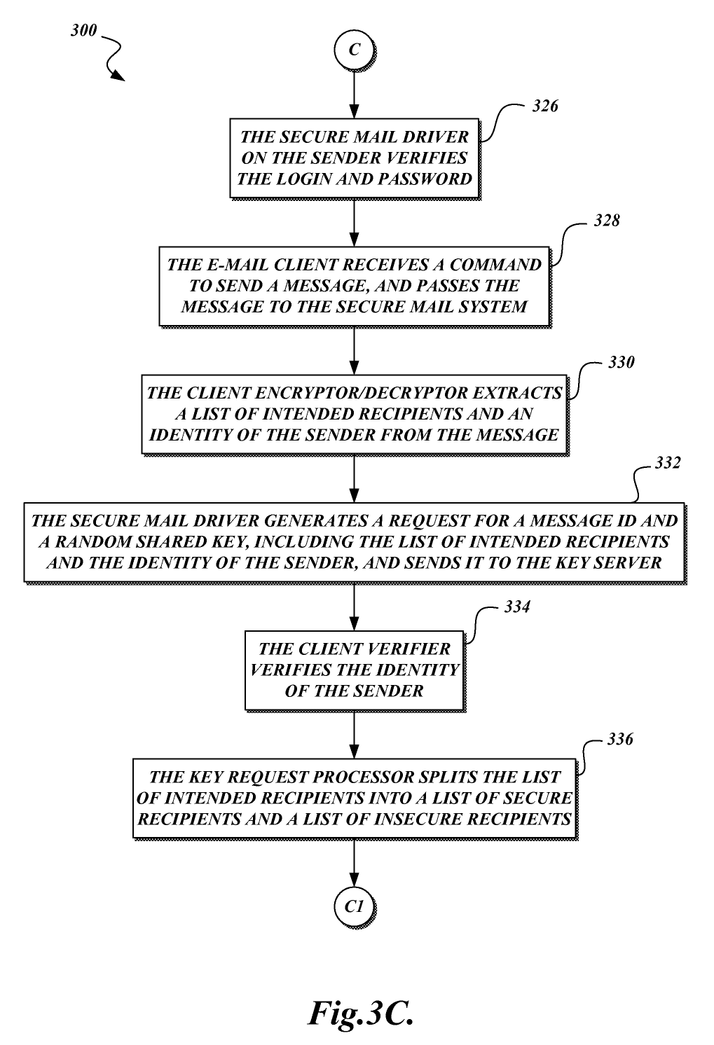

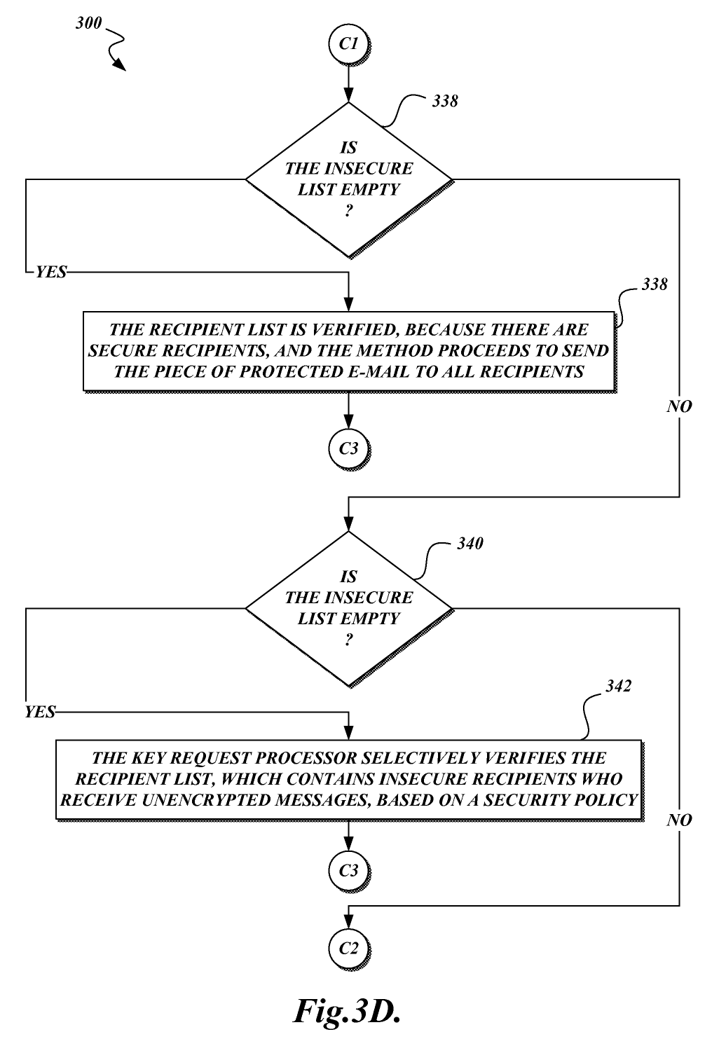

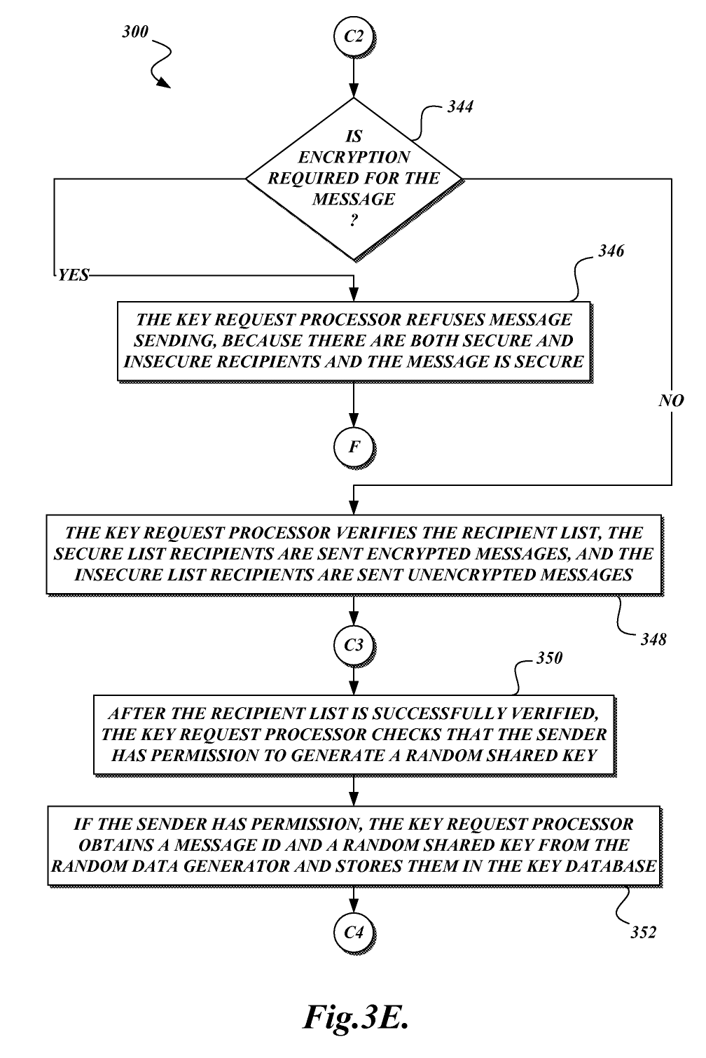

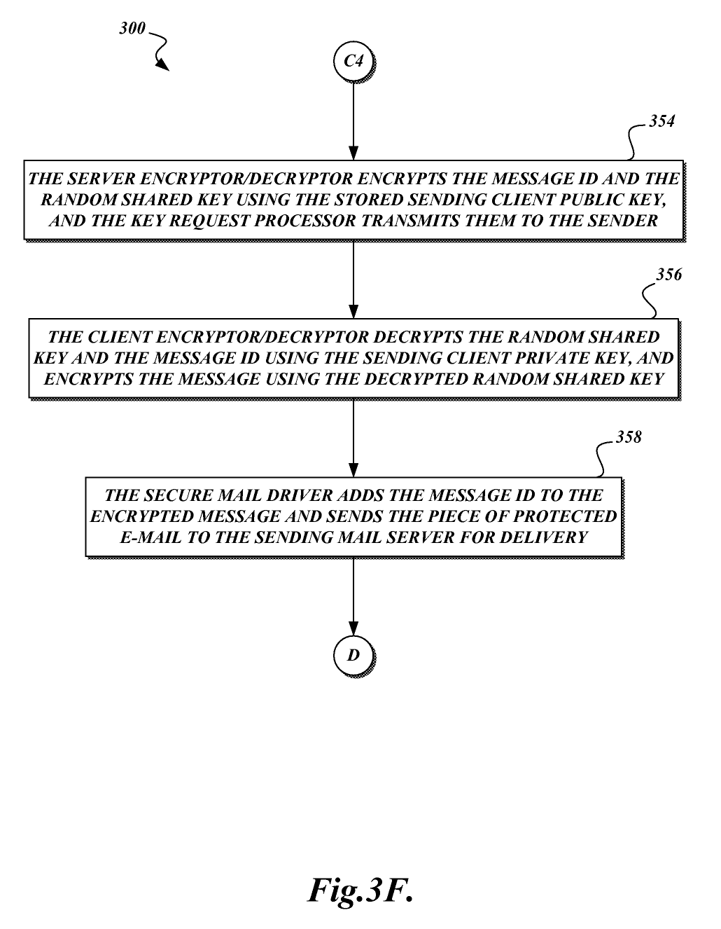

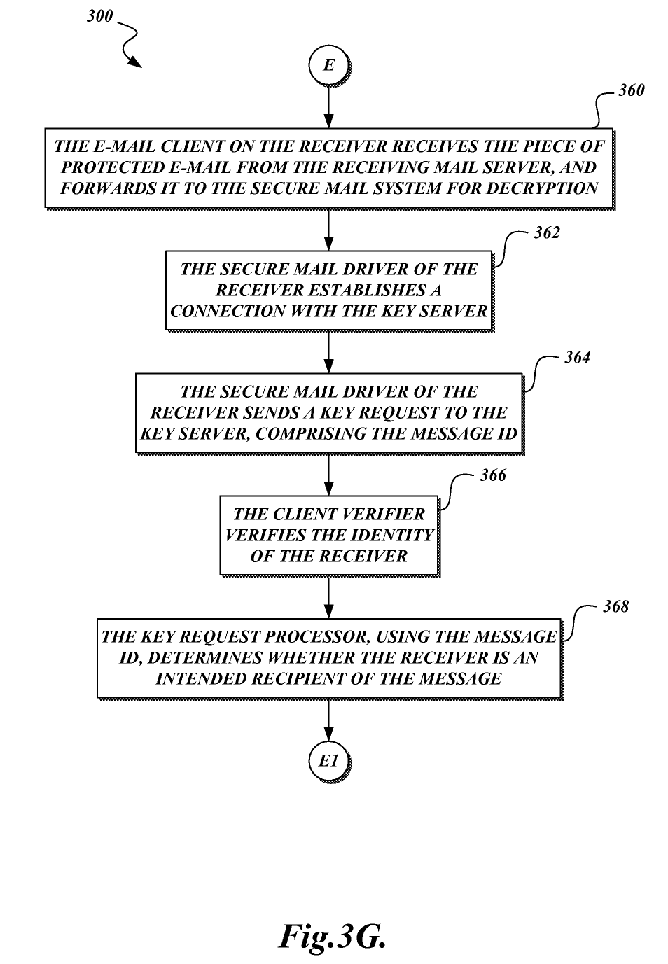

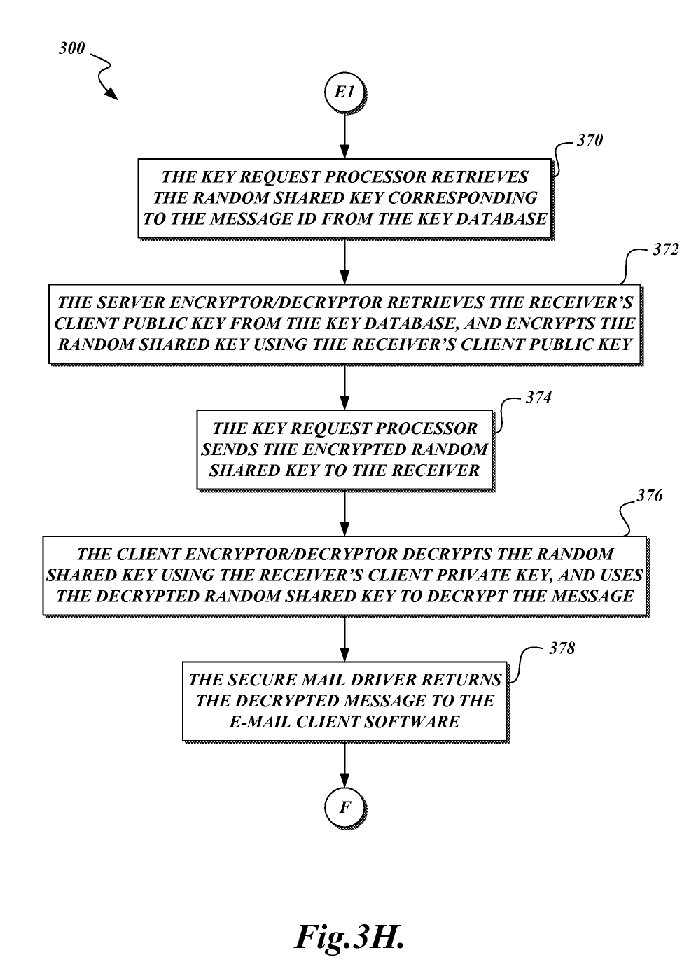

FIGS. 3A-3H illustrate a method 300 for managing encryption keys to send and receive secure e-mail. From a start block, the method 300 continues to a set of method steps 304, defined between a continuation terminal (“terminal A”) and an exit terminal (“terminal B”). The set of method steps 304 describes a method of registering the client device 100 with the key server 110. From terminal A (FIG. 3B), the method 300 proceeds to block 312, where the secure mail system 104 is installed on the client device 100. Next, at block 314, the secure mail system 104 assigns a login and password to the client device 100. In one embodiment, the secure mail system 104 prompts a user of the client device 100 to enter the login and/or password. In another embodiment, the secure mail system 104 automatically assigns the login and password to the client device 100 without requiring user intervention. In yet another embodiment, the secure mail system 104 receives the login and password from a separate device.

The method 300 then proceeds to block 316, where the secure mail system 104 generates a client public key and a client private key. In one embodiment, the client private key is then stored by the client device 100 for later use. Next, at block 318, the secure mail system 104 generates a registration request that includes the client public key, and at block 320, the secure mail system 104 transmits the registration request to the client registrar 112.

Next, at block 322, the client registrar 112 generates a server public key and a server private key, and stores the server public key, the server private key, and the client public key in the key database 122. In one embodiment, the client registrar 112 does not generate the server public key and the server private key if the server public key and the server private key have already been generated for the key server 110. In another embodiment, a new server public key and a new server private key are generated for each client device 100 registering with the client registrar 112. After these keys have been generated and stored, the method 300 continues to block 324, where the client registrar 112 sends the server public key to the client device 100, and then continues to terminal B.

From terminal B (FIG. 3A), the method 300 proceeds to a set of method steps 306 defined between a continuation terminal (“terminal C”) and an exit terminal (“terminal D”). The set of method steps 306 depicts a method of encrypting and sending a piece of protected e-mail.

From terminal C (FIG. 3C), the method 300 proceeds to block 326, where the secure mail driver 108 on the sender 202 authenticates the client device 100 by verifying the login and password. The method 300 then proceeds to block 328, where the e-mail client 102 receives a command to send a message, and passes the message to the secure mail system 104. Next, at block 330, the client encryptor/decryptor 106 extracts a list of intended recipients and an identity of the sender 202 from the message. The method 300 then proceeds to block 332, where the secure mail driver 108 generates a request for a message ID and a random shared key, the request including the list of intended recipients and the identity of the sender 202. The method 300 then sends this request to the key server 110.

In one embodiment, the request generated by the secure mail driver 108 is sent to the key server 110 in a secure manner. To do this, the secure mail driver 108 encrypts the request using the public key of the key server 110. The key server 110, once it receives the request, decrypts the request using the private key of the key server 110. In another embodiment, a different encryption protocol is used to secure the communication between the secure mail driver 108 and the key server 110.

The method 300 then proceeds to block 334, where the client verifier 118 verifies the identity of the sender 202. This verification of the identity of the sender 202 may be done by many suitable techniques. One suitable technique includes the RSA verify procedure, but other suitable verification routines can be used.

The method 300 then proceeds to block 336, where the key request processor 116 splits the list of intended recipients into a list of secure recipients and a list of insecure recipients. In one embodiment, the key request processor 116 determines which recipients are secure recipients and which recipients are insecure recipients based on either whether the recipients are registered with the key server 110, or whether information relating to the intended recipient can be found in the key database 122. In another embodiment, the sender 202 is responsible for determining which recipients are secure recipients and which recipients are insecure recipients. The method 300 then proceeds to another continuation terminal (“terminal C1”).

From terminal C1 (FIG. 3D), the method 300 proceeds to decision block 338, where a test is performed to determine whether the list of insecure recipients is empty. If the answer to the test at decision block 338 is YES, the method proceeds to block 338, where the recipient list is considered verified. The recipient list is considered verified because there are secure recipients and not insecure recipients, and the method 300 will eventually send the encrypted version of the message to all intended recipients. The method 300 then proceeds to another continuation terminal (“terminal C3”). Otherwise, if the answer to the test at decision block 338 is NO, the method 300 proceeds to decision block 340, where a test is performed to determine whether the secure list is empty. If the answer to the test at decision block 340 is YES, the method 300 then proceeds to block 342, where the key request processor 116 selectively verifies the recipient list. At this point, the method 300 has determined that the message is being sent to insecure recipients and not being sent to secure recipients. The method 300 decides whether or not to allow the sender 202 to send the unencrypted message to the insecure recipients based on a security policy. The method 300, assuming that the security policy allows the message to be sent, then proceeds to terminal C3. Otherwise, if the answer to the test at decision block 340 is NO, the method 300 proceeds to another continuation terminal (“terminal C2”).

From terminal C2 (FIG. 3E), the method 300 continues to decision block 344, where a test is performed to determine whether encryption is required for the message. If the answer to the test at decision block 344 is YES, the method 300 proceeds to block 346. At block 346, the key request processor 116 refuses message sending, because the recipients of the message include both secure and insecure recipients; therefore, since the message is to be sent securely, it would not be possible to send the message to the insecure recipients. The method 300 then continues to terminal F, and terminates. Otherwise, if the answer to the test at decision block 344 is YES, the method 300 proceeds to block 348. The key request processor 116 at least substantially ensures that secure list recipients are sent encrypted copies of the message, and that insecure list recipients are sent unencrypted copies of the message. The method 300 then proceeds to terminal C3.

From terminal C3, the method 300 proceeds to block 350, where the key request processor 116 checks that the sender 202 has permission to generate a random shared key. In this way, a system administrator of the key server 110 can at least substantially ensure that authorized users are able to send encrypted messages without unauthorized users being able to send encrypted messages. This can also allow a system administrator to at least substantially ensure that, for example, a piece of protected e-mail sent on behalf of the CEO of a company is sent by senders who are authorized to do so. Next, the method 300 proceeds to block 352, where, if the sender 202 has permission, the key request processor 116 obtains a message ID and a random shared key from the random data generator 120 and stores them along with the recipient list in the key database 122. The method 300 then proceeds to another continuation terminal (“terminal C4”).

From terminal C4 (FIG. 3F) the method 300 proceeds to block 354, where the server encryptor/decryptor 114 encrypts the message ID and the random shared key using the stored sending client public key, and the key request processor 116 transmits them to the sender 202. The encryption of the message ID and the random shared key 204 using the stored sending client public key further at least substantially ensures the security of the message ID and the random shared key 204. The method 300 then proceeds to block 356 where the client encryptor/decryptor 106 decrypts the message ID and the random shared key 204 using the sending client private key, and encrypts the message using the decrypted shared key. From there, the method 300 proceeds to block 358, where the secure mail driver 108 adds the message ID to the unencrypted headers of the encrypted message and sends the piece of protected e-mail 206 to the sending mail server 208 for delivery. In this way, the contents of the message other than the message ID (which is required by the receiver 214 to obtain the random shared key from the key server 110) are encrypted and protected from viewing by unauthorized third parties. The method 300 then proceeds to another continuation terminal (“terminal D”).

From terminal D (FIG. 3A), the method 300 proceeds to a set of method steps 308 defined between terminal E and terminal F. The set of method steps 308 describes that the method 300 obtains the random shared key and decrypts the received piece of protected e-mail. From terminal E (FIG. 3G), the method 300 continues to block 360, when the e-mail client 102 on the receiver 214 receives the piece of protected e-mail 206 from the receiving mail server 212 and forwards it to the secure mail system 104 for decryption. The method 300 proceeds to block 362, where the secure mail driver 108 of the receiver 214 establishes a connection with the key server 110. In one embodiment, the key server 110 contacted by the receiver 214 is the same key server as that contacted by the sender 202. In another embodiment, the key server 110 contacted by the receiver 214 is different than the key server 110 contacted by the sender 202, but the two key servers share the key database 122 in common.

The method 300 next proceeds to block 364, where the secure mail driver 108 of the receiver 214 sends a key request to the key server 110, the key request comprising the message ID. The secure mail driver 108 of the receiver 214 extracts the message ID for this key request from the piece of protected e-mail 206. The method 300 then proceeds to block 366, where the client verifier 118 verifies the identity of the receiver 214. As discussed above, this may be done via any one of a number of verifying routines.

The method 300 then proceeds to block 368, where the key request processor 116, using the message ID, determines whether the receiver 214 is an intended recipient of the piece of protected e-mail 206. If the receiver 214 is not an intended recipient of the piece of protected e-mail 206, the method 300 terminates, and the receiver 214 will be unable to decrypt the piece of protected e-mail 206. If the receiver 214 is an intended recipient of the piece of protected e-mail 206, the method 300 proceeds to another continuation terminal (“terminal E1”).

From terminal E1 (FIG. 3H), the method 300 continues to block 370, where the key request processor 116 retrieves the random shared key corresponding to the message ID from the key database 122. The method 300 then proceeds to block 372, where the server encryptor/decryptor 114 retrieves the client public key of the receiver 214 from the key database 122 and encrypts the random shared key using the client public key of the receiver 214. As with the communication between the sender 202 and the key server 110, this allows the communication between the key server 110 and the receiver 214 to be secured. The method 300 then proceeds to block 374, where the key request processor 116 sends the encrypted random shared key 204 to the receiver 214. Next, the method 300 proceeds to block 376, where the client encryptor/decryptor 106 decrypts the random shared key using the client private key of the receiver 214 and uses the decrypted random shared key to decrypt the piece of protected e-mail 206. Next, at block 378, the secure mail driver 108 returns the decrypted message to the e-mail client 102. From block 378, the method 300 proceeds to terminal F and terminates.

While illustrative embodiments have been illustrated and described, it will be appreciated that various changes can be made therein without departing from the spirit and scope of the claimed subject matter.

What is claimed is:

1. A system, comprising:
a key server configured to execute on a computer, the key server configured to programmatically respond to a request by a sender by generating a message identifier connected with a message to be communicated and a random shared key for encrypting the message by the sender if the sender has registered with the key server, the key server further configured to programmatically respond to a receiver by extracting the random shared key for decrypting the message if the receiver has registered with the key server, the receiver provides the message identifier to the key server, and the receiver is an intended recipient of the message.

2. The system of claim 1, wherein the key server comprises a client registrar configured to execute on the computer, the client registrar configured to register the sender and the receiver by storing an identifier of the sender, an identifier of the receiver, a public key associated with the sender, and a public key associated with the receiver.

3. The system of claim 1, wherein the key server further comprises a key request processor configured to execute on the computer, the key request processor configured to split a list of intended recipients of the message into a list of secure recipients and a list of insecure recipients, the key request processor selectively processing the request by the sender if there is at least one insecure recipient.

4. The system of claim 1, wherein the key server further comprises a client verifier configured to verify the identity of the sender or the identity of the receiver.

5. The system of claim 1, wherein the key server further comprises a random data generator configured to generate data suitable for use as the message identifier or the random shared key.

6. The system of claim 1, wherein the key server further comprises a server encryptor/decryptor configured to decrypt communication from either the sender or the receiver and to encrypt communication to either the sender or the receiver.

7. The system of claim 6, wherein the key server further comprises a key database configured to store the identifier of the sender, the identifier of the receiver, and the public keys associated with the sender and the receiver, and wherein the server encryptor/decryptor is configured to use information stored in the key database to encrypt and decrypt communication from and to the sender or the receiver.

8. The system of claim 1, further comprising a client device on which either the sender or the receiver executes, the client device including an e-mail client for causing either the message to be sent or received.

9. The system of claim 8, wherein the client device further includes a secure mail driver that is configured to establish a connection with the key server in response to a command from the sender to send the message, the secure mail driver sending to the key server the request for the message identifier and the random shared key.

10. The system of claim 9, wherein the client device further includes a client encryptor/decryptor configured to decrypt the random shared key using a private key of the sender or a private key of the receiver, the client encryptor/decryptor further configured to encrypt the message by using the random shared key prior to sending the message to the receiver.

11. A computer-executed method for distributing keys, comprising:
generating and transmitting a random shared key and a message identifier in response to a request from a registered sending client device; and
transmitting the random shared key in response to a request from a registered receiving client device, the request from the registered receiving client device comprising the message identifier.

12. The method of claim 11, further comprising determining whether the registered sending client device is properly authorized to send the request, and if not, refusing to transmit the random shared key and the message identifier in response to the request from the registered sending client device.

13. The method of claim 11, further comprising receiving and storing a list of intended recipients from the registered sending client device.

14. The method of claim 11, further comprising determining whether the registered receiving client device is associated with the list of intended recipients, and if not, refusing to transmit the random shared key in response to the request from the registered receiving client device.

15. The method of claim 11, further comprising encrypting the random shared key and the message identifier before transmitting them to the registered sending client device.

16. The method of claim 11, further comprising encrypting the random shared key before transmitting it to the registered receiving client device.

17. A computer-readable medium having computer-executable instructions stored thereon for implementing a computer-implementable method for distributing keys, the method comprising:
registering a sending client device and a receiving client device;
generating and transmitting a random shared key and a message identifier in response to a request from the sending client device; and
transmitting the random shared key in response to a request from the receiving client device, the request from the receiving client device comprising the message identifier.

18. The computer-readable medium of claim 15, the method further comprising determining whether the sending client device is properly authorized to send the request, and if not, refusing to transmit the random shared key and the message identifier in response to the request from the sending client device.

19. The computer-readable medium of claim 15, the method further comprising receiving and storing a list of intended recipients from the sending client device.

20. The computer-readable medium of claim 15, the method further comprising determining whether the receiving client device is associated with the list of intended recipients, and if not, refusing to transmit the random shared key in response to the request from the receiving client device.
